(19) United States
(12) Patent Application Publication
(10) Pub. No.: US 2007/0060496 A1
(43) Pub. Date: Mar. 15, 2007

(54) Use of surface tension reducing agents in a fabric treatment composition

(76) Inventors: Christopher Boardman, Merseyside (GB); Gillian Sheila Mchattie, Merseyside (GB); Neil Fletcher Taylor, Merseyside (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/557,569

(22) PCT Filed: Apr. 22, 2004
(86) PCT No.: PCT/EP04/04258

§ 371 Date: Nov. 21, 2005

(30) Foreign Application Priority Data
May 21, 2003 (GB) 0311699.3
May 21, 2003 (GB) 0311700.9

(51) Int. Cl. C11D 3/00

(52) U.S. Cl. 510/515

(57) ABSTRACT

The use of a surface tension reducing agent in a fabric treatment composition reduces the drying time of laundered fabrics. Preferably the surface tension reducing agent is a cationic, anionic, zwitterionic or amphoteric surfactant.

### FIELD OF THE INVENTION

The present invention relates to the use of surface tension reducing agents in a fabric treatment composition. More specifically, the present invention relates to the use of surface tension reducing agents in a fabric treatment composition to reduce the drying time of laundered fabrics.

### BACKGROUND OF THE INVENTION

In the treatment of laundry, there is typically a long drying process required after a batch of fabrics has been washed. Traditionally, this has involved hanging the laundered fabrics on a line in an outdoor environment for a period of several hours. Of course, this has always been subject to the risk of adverse weather conditions, such as rain, which could cause a substantial prolongation of the drying time.

It has also been common to provide an indoor drying line which is for instance, hung over a bath. Again, full drying typically takes several hours or longer.

Since the advent of the automatic tumble dryer, the drying process has become significantly more rapid. However, such a benefit comes at a cost of increased power consumption which presents an additional cost to the consumer and is environmentally less expedient.

It is therefore desirable to reduce the drying time of laundered fabrics when both line dried and machine tumble dried.

EP-A1-224839 and EP-A1-200325 both disclose that silicone may be dispersed in rinse water combined with other laundry additives such as fabric conditioning compositions to reduce the drying time of fabrics. The silicone is in addition to any fabric conditioning composition which may be added.

WO 01/73187 discloses a method for reducing the drying time of fabric comprising treating the fabric with a treatment composition comprising formaldehyde, a catalyst for crosslinking the formaldehyde with natural fibres in the fabric, and silicone elastomer or a precursor thereof, and heating the treated fabric to effect crosslinking of the formaldehyde. This is a complex operation which requires a heating stage to effect a chemical reaction within the components.

U.S. Pat. No. 4,337,166 discloses a fast-dry shampoo composition which contains cyclic methyl siloxanes.

WO-A1-01/60961 discloses laundry compositions containing superwetting silicones for enhanced penetration of active ingredients and anti-wrinkles benefits.

It has now been found that a rinse added composition comprising a surface tension reducing agent can be used to reduce the drying time of laundered fabrics.

### OBJECTS OF THE INVENTION

The present invention seeks to address one or more of the aforementioned problems and to provide one or more of the aforementioned benefits.

### STATEMENT OF INVENTION

Thus, according to the present invention there is provided the use of a surface tension reducing agent in a fabric treatment composition to reduce the drying time of laundered fabrics.

### DETAILED DESCRIPTION OF THE INVENTION

In the context of the present invention, the term “comprising” denotes that the feature(s) to which it refers is/are not exhaustive and further features may be present.

Surface Tension Reducing Agent

The composition comprises a surface tension reducing agent. Suitable agents include, for example, cationic, anionic, zwitterionic and amphoteric surfactants.

Without wishing to be bound by theory, it is believed that a relationship exists between the amount of water left on fabrics after the spin and the surface tension of the rinse liquor such that the lower the surface tension (or more specifically the air-liquor interfacial tension) of the rinse liquor, the more water is spun off, and hence less water remains on the fabric.

Anionic Surfactants

The composition may comprise an anionic surfactant

Many suitable compounds of this type are available and are fully described in the literature, for example, in “Surface-Active Agents and Detergents”, Volumes I and II, by Schwartz, Perry and Berch.

The preferred anionic surfactants that can be used are soaps and synthetic non-soap anionic compounds.

Anionic surfactants are well-known to those skilled in the art. Examples include alkylbenzene sulphonates, particularly linear alkylbenzene sulphonates having an alkyl chain length of C₈-C₁₅; primary and secondary alkylsulphates, particularly C₈-C₁₅ primary alkyl sulphates; alkyl ether sulphates; olefin sulphonates; alkyl xylene sulphonates; dialkyl sulphosuccinates; and fatty acid ester sulphonates. Sodium salts are generally preferred.

Amphoteric Surfactants

Amphoteric surfactants may also be used, for example amine oxides or betaines.

Cationic Surfactants

The cationic surfactant is preferably a quaternary ammonium fabric softening material.

The quaternary ammonium fabric softening material compound has two C₁₂₋₂₈ alkyl or alkenyl groups connected to the nitrogen head group, preferably via at least one ester link. It is more preferred if the quaternary ammonium material has two ester links present.

Preferably, the average chain length of the alkyl or alkenyl group is at least C₁₄, more preferably at least C₁₆. Most preferably at least half of the chains have a length of C₁₈.

It is generally preferred if the alkyl or alkenyl chains are predominantly linear.

The first group of cationic fabric softening compounds for use in the invention is represented by formula (I): 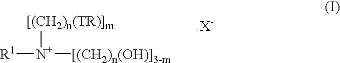
wherein each R is independently selected from a C₅₋₃₅ alkyl or alkenyl group, R¹ represents a C₁₋₄ alkyl, C₂₋₄ alkenyl or a C₁₋₄ hydroxyalkyl group,

T is

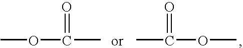

n is 0 or a number selected from 1 to 4, m is 1, 2 or 3 and denotes the number of moieties to which it relates that pend directly from the N atom, and X is an anionic group, such as halides or alkyl sulphates, e.g. chloride, methyl sulphate or ethyl sulphate.

Especially preferred materials within this formula are di-alkenyl esters of triethanol ammonium methyl sulphate. Commercial examples include Tetranyl AHT-1 (di-hardened oleic ester of triethanol ammonium methyl sulphate 80% active), AT-1(di-oleic ester of triethanol ammonium methyl sulphate 90% active), L5/90 (palm ester of triethanol ammonium methyl sulphate 90% active), all ex Kao and Rewoquat WE15 (C₁₀-C₂₀ and C₁₆-C₁₈ unsaturated fatty acid reaction products with triethanolamine dimethyl sulphate quaternised 90% active), ex Witco Corporation.

The second group of cationic fabric softening compounds for use in the invention is represented by formula (II): 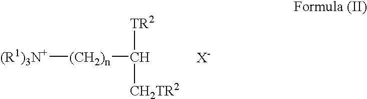
wherein each R group is independently selected from C₁₋₄ alkyl, hydroxyalkyl or C₂₋₄ alkenyl groups; and wherein each R² group is independently selected from C₈₋₂₈ alkyl or alkenyl groups; n is 0 or an integer from 1 to 5 and T and X⁻ are as defined above.

Preferred materials of this class such as 1,2 bis[tallowoyloxy]-3-trimethylammonium propane chloride and 1,2-bis[oleyloxy]-3-trimethylammonium propane chloride and their method of preparation are, for example, described in U.S. Pat. No. 4,137,180 (Lever Brothers), the contents of which are incorporated herein. Preferably these materials also comprise small amounts of the corresponding monoester, as described in U.S. Pat. No. 4,137,180.

A third group of cationic fabric softening compounds for use in the invention is represented by formula (III): 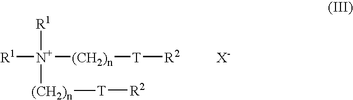
wherein each R¹ group is independently selected from C₁₋₄ alkyl, or C₂₋₄ alkenyl groups; and wherein each R group is independently selected from C₈₋₂₈ alkyl or alkenyl groups; n is 0 or an integer from 1 to 5 and T and X⁻ are as defined above.

A fourth group of cationic fabric softening compounds for use in the invention is represented by formula (IV): 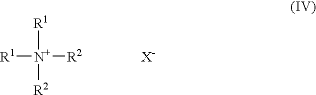
wherein each R¹ group is independently selected from C₁₋₄ alkyl, or C₂₋₄ alkenyl groups; and wherein each R group is independently selected from C₈₋₂₈ alkyl or alkenyl groups; and X⁻ is as defined above.

Iodine Value of the Parent Fatty Acyl group or Acid

The iodine value of the parent fatty acyl compound or acid from which the cationic softening material is formed is from 0 to 140, preferably from 0 to 100, more preferably from 0 to 60.

It is especially preferred that the iodine value of the parent compound is from 0 to 20, e.g. 0 to 4. Where the iodine value is 4 or less, the softening material provides excellent softening results and has improved resistance to oxidation and associated odour problems upon storage.

When unsaturated hydrocarbyl chains are present, it is preferred that the cis:trans weight ratio of the material is 50:50 or more, more preferably 60:40 or more, most preferably 70:30 or more, e.g. 85:15 or more.

The iodine value of the parent fatty acid or acyl compound is measured according to the method set out in respect of parent fatty acids in WO-A1-01/46513.

The softening material is preferably present in an amount of from 1 to 60% by weight of the total composition, more preferably from 2 to 40%, most preferably from 3 to 30% by weight.

Silicone

It may be desirable for a silicone to be present in the composition.

Typical silicones for use in the composition are siloxanes which have the general formula RₐSiO_{(4-a)/2} wherein each R is the same or different and is selected from hydrocarbon and hydroxyl groups, “a” being from 0 to 3. In the bulk material, “a” typically has an average value of from 1.85-2.2.

The silicone can have a linear or cyclic structure.

Preferably, the silicone is a polydi-C₁₋₆alkyl siloxane.

Particularly preferred is polydimethyl siloxane. The siloxane is preferably end-terminated, if linear, either by a tri-C₁₋₆ alkylsilyl group (e.g. trimethylsilyl) or a hydroxy-di-C₁₋₆ alkylsilyl group (e.g. hydroxy-dimethylsilyl) groups, or by both.

More preferably the silicone is a cyclic polydimethyl siloxane.

Suitable commercially available silicones include DC245 (polydimethylcyclopentasiloxane also known as D5), DC246 (polydimethylcyclohexasiloxane also known as D6), DC1184 (a pre-emulsified polydimethylpentasiloxane also known as L5) and DC347 (a pre-emulsified 100 cSt PDMS fluid) all ex Dow Corning.

Silicone Form

If present, the silicone may be received and incorporated into the composition either directly as an oil or pre-emulsified.

Pre-emulsification is typically required when the silicone is of a more viscous nature.

Suitable emulsifiers include cationic emulsifiers, nonionic emulsifiers or mixtures thereof.

If emulsified it is preferred that the silicone droplets are incorporated in the form of a macro-emulsion, that is to say the droplets have a median size in the wavelength range corresponding to the visible spectrum, or even larger. Preferably, the emulsion is an oil-in-water emulsion. The term “median size” refers to the number average. The visible spectrum is 0.39 μm to 0.77 μm. In the emulsion, the silicone droplets are then preferably from 0.39 μm to 25 μm. The droplet size may be determined based on measurements of median DV05 using a Malvern X Mastersizer.

Emulsification can be effected using one or more cationic surfactants, preferably having a non-halogen counter-ion.

The cationic emulsifiers are believed to enhance deposition of the silicone during use of the fabric softening composition. Preferred counter-ions include methosulphate, ethosulphate, tosylate, phosphate and nitrate. If a halogen counter-ion is used, it is preferably chloride.

If an emulsifier is present, it is desirable that the total of amount of emulsifying surfactant(s) is from 0.5% to 20%, preferably from 2% to 12%, more preferably from 3% to 10% by weight of the emulsion.

The total amount of silicone in the emulsion will generally be up to 70% by weight of the emulsion.

Preferably, the weight ratio of silicone to total emulsifying surfactant(s) is from 2.3:1 to 120:1, more preferably 3:1 to 120:1, for example from 3:1 to 30:1. Typical cationic surfactants are alkyl tri-methylammonium methosulphates and derivatives in which at least two of the methyl groups on the nitrogen atom are replaced by (poly)alkoxylated groups.

Silicone Viscosity

The reference to the viscosity of the silicone denotes the viscosity of the silicone itself when provided as an oil for incorporation into the fabric conditioning composition.

The silicone preferably has a viscosity (as measured on a Brookfield RV4 viscometer at 25° C. using spindle No.4 at 100 rpm) of from 1 cSt to 500,000 cSt. It is more preferred than the viscosity of the silicone is less than 10,000 centi-Stokes (cSt), preferably from 1 cSt to 5,000 cSt, more preferably from 2 cSt to 1,000 cSt and most preferably 2 cSt to 100 cSt.

It is also possible to provide the silicone as an emulsion which is then incorporated into the composition. For such silicones, the viscosity before emulsification (as measured on a Brookfield RV4 viscometer at 25° C. using spindle No.4 at 100 rpm) is preferably from 1 cSt to 1,000,000 cSt, preferably from 30,000 cSt to 750,000 cSt, more preferably from 40,000 cSt to 400,000 cSt, most preferably 45,000 cSt to 250,000 cSt, eg 45,000 cSt to 200,000 cSt.

The silicone active ingredient is preferably present at a level of from 0.5 to 20%, more preferably from 1 to 12%, most preferably from 2 to 8% by weight, based on the total weight of the composition.

Fatty Alcohol

Optionally and advantageously, one or more un-alkoxylated fatty alcohols are present in the composition.

Preferred alcohols have a hydrocarbyl chain length of from 10 to 22 carbon atoms, more preferably 11 to 20 carbon atoms, most preferably 15 to 19 carbon atoms.

The fatty alcohol may be saturated or unsaturated, though saturated fatty alcohols are preferred as these have been found to deliver greater benefits in terms of stability, especially low temperature stability.

Suitable commercially available fatty alcohols include tallow alcohol (available as Hydrenol S3, ex Sidobre Sinnova, and Laurex CS, ex Clariant).

The fatty alcohol content in the compositions is from 0 to 10% by weight, more preferably from 0.005 to 5% by weight, most preferably from 0.01 to 3% by weight, based on the total weight of the composition.

It is particularly preferred that a fatty alcohol is present if the composition is concentrated, that is if more than 8% by weight of the cationic softening agent is present in the composition.

Perfume

The compositions of the invention preferably comprise one or more perfumes.

It is well known that perfume is provided as a mixture of various components. Suitable components for use in the perfume include those described in “Perfume and Flavor Chemicals (Aroma Chemicals) by Steffen Arctander, published by the author 1969 Montclait, N.J. (US), reprinted 1^{st} Apr. 1982 library of Congress Catalog Number 75-91398.

The perfume is preferably present in an amount from 0.01 to 10% by weight, more preferably 0.05 to 5% by weight, most preferably 0.5 to 4.0% by weight, based on the total weight of the composition.

Liquid Carrier

A liquid carrier is preferably present. Suitable liquid carriers employed in the compositions are at least partly water due to its low cost relative availability, safety, and environmental compatibility. The level of water in the liquid carrier is more than about 50%, preferably more than about 80%, more preferably more than about 85%, by weight of the carrier. The level of liquid carrier is greater than about 50%, preferably greater than about 65%, more preferably greater than about 70%. Mixtures of water and a low molecular weight, e.g. <100, organic solvent, e.g. a lower alcohol such as ethanol, propanol, isopropanol or butanol are useful as the carrier liquid. Low molecular weight alcohols including monohydric, dihydric (glycol, etc.) trihydric (glycerol, etc.), and polyhydric (polyols) alcohols are also suitable carriers for use in the compositions of the present invention.

Other Co-Active Softeners

Co-active softeners for the cationic surfactant may also be incorporated in an amount from 0.01 to 20% by weight, more preferably 0.05 to 10%, based on the total weight of the composition. Preferred co-active softeners include fatty esters, and fatty N-oxides.

Preferred fatty esters include fatty monoesters, such as glycerol monostearate (hereinafter referred to as “GMS”). If GMS is present, then it is preferred that the level of GMS in the composition is from 0.01 to 10% by weight, based on the total weight of the composition.

The co-active softener may also comprise an oily sugar derivative. Suitable oily sugar derivatives, their methods of manufacture and their preferred amounts are described in WO-A1-01/46361 on page 5 line 16 to page 11 line 20, the disclosure of which is incorporated herein.

Polymeric Viscosity Control Agents

It is useful, though not essential, if the compositions comprise one or more polymeric viscosity control agents. Suitable polymeric viscosity control agents include nonionic and cationic polymers, such as hydrophobically modified cellulose ethers (e.g. Natrosol Plus, ex Hercules), cationically modified starches (e.g. Softgel BDA and Softgel BD, both ex Avebe). A particularly preferred viscosity control agent is a copolymer of methacrylate and cationic acrylamide available under the tradename Flosoft 200 (ex SNF Floerger).

Nonionic and/or cationic polymers are preferably present in an amount of 0.01 to 5 wt %, more preferably 0.02 to 4 wt %, based on the total weight of the composition.

Product Form

The product may be a liquid or solid. Preferably the product is a liquid which, in its undiluted state at ambient temperature, comprises an aqueous liquid, preferably an aqueous dispersion.

### EXAMPLES

The invention will now be illustrated by the following non-limiting examples. Further modifications will be apparent to the person skilled in the art.

All values are % by weight of the active ingredient unless stated otherwise.

In the following example, 3 stacks of 3 Terry Monitors (20×20 cm) were weighed and rinsed in a beaker containing a rinse liquor. The rinse liquor comprised either 1.54 g of a commercially available fabric softener (Concentrated Comfort) in 660 ml of water or 1.54 g of a commercially available fabric softener (Concentrated Comfort) containing a 5% dispersion of Surfadone LP300 in 660 ml water.

After rinsing, the monitors were then removed from the liquor, hand wrung, placed flat against the side of a washing machine drum and secured with tape. A single spin at 1200 rpm was then carried out.

The monitors were the removed, reweighed and the level of water retention calculated in the manner described above.

Water retention at this stage was calculated using the following equation:

$$\begin{matrix}\% water retention \\ of fabric\end{matrix} = 100 \times ( \frac{( wet weight - dry weight )}{dry weight} )$$

For each sample, the test was replicated and the result averaged.

Surface tension measurements were then carried out on a Tensiometer Tracker (I.T. Concept). The method used a rising pendant air droplet injected from a needle into a test solution, with software calculation based on the shape of the air droplet using video technique.

TABLE 1

| | Water | Dynamic surface |
|---|---|---|
| Material | retention | tension (mN/m) |
| Concentrated | 56.7 | 67.5 |
| Comfort (1) | | |
| n-dodecyl-2- | 50.7 | 43.1 |
| pyrrolidone (2) | | |

(1) purchased in UK March 2002
(2) Surfadone LP300, ex International Speciality Products; a cationic surfactant

1. Use of a surface tension reducing agent in a fabric treatment composition to reduce the drying time of laundered fabrics.

2. Use according to claim 1 in which the fabric treatment composition is a fabric softening composition.

3. Use according to claim 1 in which the surface tension reducing agent is a cationic surfactant

4. Use according to claim 1 in which the surface tension reducing agent is an anionic surfactant.

5. Use according to claim 1 in which the surface tension reducing agent is a zwitterionic surfactant.

6. Use according to claim 1 in which the surface tension reducing agent is an amphoteric surfactant.

7. Use according to claim 1 in which the surface tension reducing agent is present in an amount of from 1 to 60 wt %, based on the total weight of the composition.

8. Use according to claim 1 in which the composition is in the form of an aqueous dispersion.
